(19) United States
(12) Patent Application Publication
(10) Pub. No.: US 2014/0244244 A1
(43) Pub. Date: Aug. 28, 2014

(54) APPARATUS AND METHOD FOR PROCESSING FREQUENCY SPECTRUM USING SOURCE FILTER

(71) Applicant: ELECTRONICS AND TELECOMMUNICATIONS RESEARCH INSTITUTE, Daejeon (KR)

(72) Inventors: Jong Mo SUNG, Daejeon (KR); Seung Kwon BEACK, Seoul (KR); Tae Jin LEE, Daejeon (KR); Kyeong Ok KANG, Daejeon (KR)

(73) Assignee: ELECTRONICS AND TELECOMMUNICATIONS RESEARCH INSTITUTE, Daejeon (KR)

(21) Appl. No.: 14/191,929

(22) Filed: Feb. 27, 2014

(30) Foreign Application Priority Data
Feb. 27, 2013 (KR) 10-2013-0021206

(51) Int. Cl. G10L 19/02; G10L 19/04

(52) U.S. Cl. CPC G10L 19/02; G10L 19/04
USPC 704/203; 704/205

(57) ABSTRACT

A frequency spectrum processing apparatus and method using a source filter are disclosed. The frequency spectrum processing apparatus may include a first excitation spectrum generation unit to generate a first excitation spectrum using a tonal excitation spectrum according to an input signal and a gain of the tonal excitation spectrum, a second excitation spectrum generation unit to generate a second excitation spectrum using a non-tonal excitation spectrum according to the input signal and a gain of the non-tonal excitation spectrum, and an output spectrum generation unit to generate an output spectrum using the first excitation spectrum and the second excitation spectrum.

### CROSS-REFERENCE TO RELATED APPLICATION

This application claims the benefit of Korean Patent Application No. 10-2013-0021206, filed on Feb. 27, 2013, in the Korean Intellectual Property Office, the disclosure of which is incorporated herein by reference.

### BACKGROUND

1. Field of the Invention

The present invention relates to an apparatus and method for processing a frequency spectrum using a source filter, and more particularly, to an apparatus and method for encoding a frequency spectrum by expressing a modified discrete cosine transform (MDCT) spectrum using and a source filter which includes a linear predictor, a tonal codebook and a non-tonal codebook.

2. Description of the Related Art

According to a conventional method for encoding a signal in a voice and audio codec, an entire signal band is divided into a low band and a high band. Generally, waveform encoding and code-excited linear prediction (CELP) encoding methods are applied to a low band signal, thereby generating a compatible bitstream, whereas transform encoding method is applied to a high band signal.

However, since the conventional MDCT-based transform coder directly encodes MDCT coefficients depending on the input signal characteristics, it should adopt a heuristic and complicated coding schemes.

Accordingly, there is a demand for a frequency spectrum encoding method which is well-structured and independent of the characteristics of the input signal.

### SUMMARY

An aspect of the present invention provides an apparatus and method for reducing a spectral distortion by expressing a modified discrete cosine transform (MDCT) spectrum using a source filter model which includes a linear predictor, a tonal codebook and a non-tonal codebook.

According to an aspect of the present invention, there is provided a frequency spectrum processing apparatus including a first excitation spectrum generation unit to generate a first excitation spectrum using a tonal excitation spectrum and a corresponding gain of the tonal excitation spectrum from the input signal, a second excitation spectrum generation unit to generate a second excitation spectrum using a non-tonal excitation spectrum and a corresponding gain of the non-tonal excitation spectrum from the input signal, and an output spectrum generation unit to generate an output spectrum using the first excitation spectrum and the second excitation spectrum.

According to another aspect of the present invention, there is provided a frequency spectrum processing apparatus including a first spectrum transform unit to transform an input signal of a time domain into a first spectrum of a frequency domain, a linear prediction (LP) unit to determine an LP coefficient by LP analyzing the first spectrum, a tonal codebook search unit to search a tonal codebook that minimizes a difference between a second spectrum, the second spectrum which is LP synthesized by a tonal component including a periodic component of the input signal and the LP coefficient, and the first spectrum, a non-tonal codebook search unit to search a non-tonal codebook that minimizes a difference between a third spectrum, the third spectrum which is LP synthesized by a non-tonal component including an aperiodic component of the input signal and the LP coefficient, and a fourth spectrum generated by removing a contribution of the tonal codebook from the first spectrum, and a signal output unit to output an encoded signal using the LP coefficient, the tonal codebook, and the non-tonal codebook.

The first spectrum transform unit may include a gain output unit to output a quantized gain of a fifth spectrum generated using a high band spectrum formed by transforming a high band signal that includes an upper band of the input signal and a low band spectrum formed by transforming a low band signal that includes a lower band of the input signal, and a normalization unit to output the first spectrum by normalizing the fifth spectrum by the quantized gain.

The frequency spectrum processing apparatus may further include a filtering unit to output a sixth spectrum including residual information according to the LP coefficient by filtering the first spectrum by the LP coefficient.

The tonal codebook search unit may include a rearrangement unit to rearrange the sixth spectrum according to a track structure for searching for the tonal codebook, an open-loop tonal codebook output unit to output an open-loop tonal codebook based on a size component with respect to the rearranged sixth spectrum, and a closed-loop tonal codebook search unit to search for a closed-loop tonal codebook using the open-loop tonal codebook, the LP coefficient, and the first spectrum.

The open-loop tonal codebook output unit may include a pulse search unit to search for a pulse having a largest absolute value corresponding to the size component with respect to a coefficient of the sixth spectrum rearranged according to the track structure, and a codebook output unit to generate and output the open-loop tonal codebook using found pulses.

The closed-loop tonal codebook search unit may include an optimal tonal codebook setting unit to set the open-loop tonal codebook as an optimal tonal codebook, a minimum error setting unit to set an error value of the first spectrum and the second spectrum as a minimum error value, a candidate tonal codebook generation unit to generate a candidate tonal codebook by substituting a pulse corresponding to a current track in the optimal tonal codebook with a pulse corresponding to a current position of a same track, an error update unit to update the optimal tonal codebook using the candidate tonal codebook when the minimum error value is updated, and a codebook output unit to output the updated optimal tonal codebook to the closed-loop tonal codebook.

The frequency spectrum processing apparatus may further include a low band encoding unit to output a low band signal bitstream by encoding a low band signal including a lower band of the input signal, and a third spectrum transform unit to output a third spectrum by transforming a layer signal obtained by decoding the low band signal transform.

The non-tonal codebook search unit may include a contribution to remove a contribution of the tonal codebook from the first spectrum and the sixth spectrum, an open-loop delay search unit to search for an open-loop non-tonal codebook delay using the third spectrum and the contribution-removed sixth spectrum, and a closed-loop delay and gain search unit to search for the closed-loop non-tonal codebook delay and a gain using the third spectrum and the contribution-removed first spectrum.

The open-loop delay search unit may include a spectrum division unit to divide the contribution-removed sixth spectrum according to a sub-band structure set for searching for the open-loop non-tonal codebook delay, and a delay search unit to search for a delay having a largest normalized con-elation between the third spectrum and the contribution-removed sixth spectrum in an open-loop search period corresponding to a current sub-band.

The closed-loop delay and gain search unit may include a spectrum division unit to divide the contribution-removed first spectrum, according to a sub-band structure set for searching for the closed-loop non-tonal codebook, a search period determination unit to determine a closed-loop search period according to the open-loop non-tonal codebook delay, an MDCT coefficient determination unit to set the third spectrum as an excitation signal in the closed-loop search period of the current sub-band, and determine an MDCT coefficient using the LP coefficient, a delay search unit to search for a delay that minimizes an error between the MDCT coefficient and a quantized band coefficient in which the contribution of the tonal codebook is removed, and a gain determination unit to determine a gain in the delay.

According to another aspect of the present invention, there is provided a frequency spectrum processing method including generating a first excitation spectrum using a tonal excitation spectrum according to an input signal and a gain of the tonal excitation spectrum, generating a second excitation spectrum using a non-tonal excitation spectrum according to the input signal and a gain of the non-tonal excitation spectrum, and generating an output spectrum using the first excitation spectrum and the second excitation spectrum.

According to another aspect of the present invention, there is provided a frequency spectrum processing method including transforming an input signal of a time domain into a first spectrum of a frequency domain, determining a LP coefficient by LP analyzing the first spectrum, searching a tonal codebook that minimizes a difference between a second spectrum, the second spectrum which is LP synthesized by a tonal component including a periodic component of the input signal and the LP coefficient, and the first spectrum, searching a non-tonal codebook that minimizes a difference between a third spectrum, the third spectrum which is LP synthesized by a non-tonal component including an aperiodic component of the input signal and the LP coefficient, and a fourth spectrum generated by removing a contribution of the tonal codebook from the first spectrum, and a signal output unit to output an encoded signal using the LP coefficient, the tonal codebook, and the non-tonal codebook.

### Effect

According to embodiments of the present invention, a spectrum distortion may be reduced by expressing a modified discrete cosine transform (MDCT) spectrum using a a source filter model which includes linear predictor, a tonal codebook and a non-tonal codebook.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a frequency spectrum processing apparatus according to an embodiment of the present invention;

FIG. 2 is a diagram illustrating a first spectrum transform unit according to an embodiment of the present invention;

FIG. 3 is a diagram illustrating a tonal codebook search unit according to an embodiment of the present invention;

FIG. 4 is a diagram illustrating an open-loop tonal codebook output unit according to an embodiment of the present invention;

FIG. 5 is a diagram illustrating a closed-loop tonal codebook output unit according to an embodiment of the present invention;

FIG. 6 is a diagram illustrating a third spectrum transform unit according to an embodiment of the present invention;

FIG. 7 is a diagram illustrating a non-tonal codebook search unit according to an embodiment of the present invention;

FIG. 8 is a diagram illustrating an open-loop delay search unit according to an embodiment of the present invention; and

FIG. 9 is a diagram illustrating a closed-loop delay and gain search unit according to an embodiment of the present invention;

FIG. 10 is a diagram illustrating a process of searching for a tonal codebook and a non-tonal codebook, according to an embodiment of the present invention;

FIG. 11 is a diagram illustrating an encoding apparatus according to an embodiment of the present invention; and

FIG. 12 is a diagram illustrating a signal transform unit according to an embodiment of the present invention;

FIG. 13 is a diagram illustrating a source filter that outputs a modified discrete cosine transform (MDCT) spectrum, according to an embodiment of the present invention;

FIG. 14 is a flowchart illustrating a frequency spectrum processing method according to an embodiment of the present invention; and

FIG. 15 is a flowchart illustrating a spectrum transform method according to an embodiment of the present invention;

FIG. 16 is a flowchart illustrating a tonal codebook search method according to an embodiment of the present invention;

FIG. 17 is a flowchart illustrating an open-loop tonal codebook output method according to an embodiment of the present invention;

FIG. 18 is a flowchart illustrating a closed-loop tonal codebook output method according to an embodiment of the present invention;

FIG. 19 is a flowchart illustrating a non-tonal codebook search method according to an embodiment of the present invention;

FIG. 20 is a flowchart illustrating an open-loop delay search method according to an embodiment of the present invention;

FIG. 21 is a flowchart illustrating a closed-loop delay search method according to an embodiment of the present invention; and

FIG. 22 is a flowchart illustrating an output spectrum generation method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. A frequency spectrum processing method according to an embodiment of the present invention may be executed by a frequency spectrum processing apparatus.

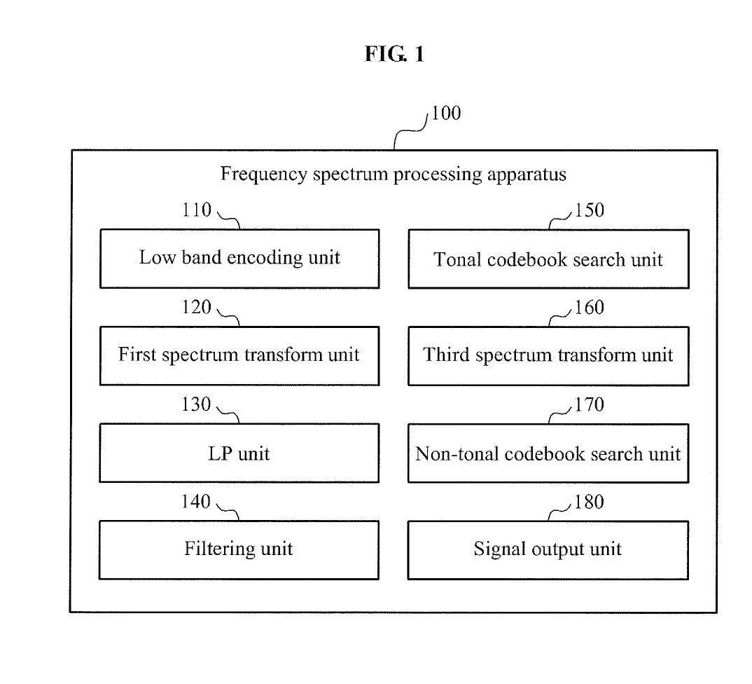

FIG. 1 is a diagram illustrating a frequency spectrum processing apparatus 100 according to an embodiment of the present invention.

The frequency spectrum processing apparatus 100 may encode a modified discrete cosine transform (MDCT) spectrum.

Referring to FIG. 1, the frequency spectrum processing apparatus 100 may include a low band encoding unit 110, a first spectrum transform unit 120, a linear prediction (LP) unit 130, a filtering unit 140, a tonal codebook search unit 150, a third spectrum transform unit 160, a non-tonal codebook search unit 170, and a signal output unit 180.

The low band encoding unit 110 may encode a signal of a low band that includes a lower band of an input signal. In detail, the low band encoding unit 110 may output a low band signal bitstream by encoding a low band signal 330 according to a predetermined encoding algorithm. Here, the low band signal bitstream may be a core layer bitstream.

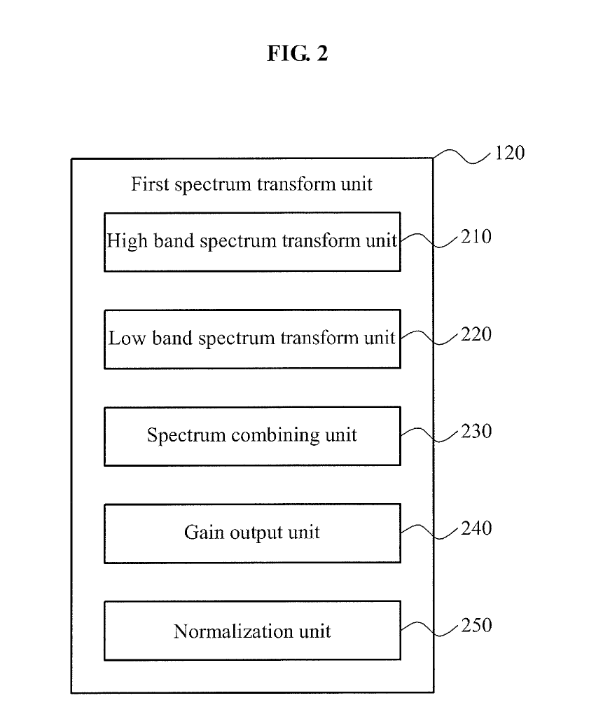

The first spectrum transform unit 120 may transmit an input signal of a time domain into a first spectrum of a frequency domain. The first spectrum transform unit 120 may perform MDCT with respect to the signal of the low band including the lower band of the input signal and a signal of a high band including an upper band of the input signal. In addition, the first spectrum transform unit 120 may output a first spectrum using an MDCT spectrum which is a combination of an MDCT spectrum not encoded by the low band encoding unit 110 among transformed low band signals and a spectrum of high band signals. Here, the first spectrum may be a normalized spectrum of the MDCT spectrum formed by combining the low band signals and the high band signals transformed into quantized gains. A configuration and operation of the first spectrum transform unit 120 will be described in detail with reference to FIG. 2.

The LP unit 130 may determine a linear prediction (LP) coefficient by LP analyzing the first spectrum. Here, the LP unit 130 may quantize the LP coefficient determined through LP analysis of the first spectrum, and output an LP coefficient bitstream corresponding to a quantized LP coefficient and a quantizing index of the LP coefficient. Furthermore, the LP unit 130 may determine the LP coefficient using the Levinson-Durbin recursion algorithm.

For example, the LP unit 130 may determine the LP coefficient, by calculating an LP coefficient set that minimizes a difference between a value estimated as a weighted sum of p-number of previous MDCT coefficients and an original MDCT coefficient with respect to an entire quantized band, as shown in Equation 1.

$$E = {\sum }_{k = 0}^{N - 1} {\{ {\overline{X}}_{QB} ( k ) - {\sum }_{i = 1}^{p} {a}_{i} {\overline{X}}_{QB} ( k - i ) \}}^{2} \qquad [ Equation 1 ]$$

Here, X̅_{QB}(k) denotes a normalized MDCT coefficient of the quantized band, and a, denotes the LP coefficient.

The filtering unit 140 may filter the first spectrum using the LP coefficient and therefore output a sixth spectrum including residual information corresponding to the LP coefficient.

The filtering unit 140 may configure an LP analyzing filter using the LP coefficient quantized by the LP unit 130 and filter the first spectrum by the LP analyzing filter, thereby outputting the sixth spectrum. The sixth spectrum may be R(k), that is, an LP residual MDCT spectrum. The filtering unit 140 may calculate R(k) using Equation 2.

$$R ( k ) = {\overline{X}}_{QB} ( k ) + {\sum }_{i = 1}^{p} {\hat{a}}_{i} {\overline{X}}_{QB} ( k - i ) \qquad [ Equation 2 ]$$

Here, âᵢ, i=1, . . . , p may be the quantized LP coefficient.

The tonal codebook search unit 150 may search for a tonal codebook that minimizes a difference between a second spectrum and the first spectrum using a track structure. Here, the second spectrum may be a spectrum LP synthesized by a tonal component including a periodic component of the input signal and the LP coefficient.

In addition, the tonal codebook search unit 150 may rearrange the sixth spectrum into the track structure. Here, pulses of tracks may be expressed by a size, a code, and a position.

For example, when N_{QB} is 64, the tonal codebook search unit 150 may rearrange the sixth spectrum into the track structure as shown in Table 1. Table 1 shows an example in which one pulse is allocated per one track and the tonal codebook includes totally eight pulses. Although one pulse is allocated per one track in the example of Table 1, a plurality of pulses may be allocated per one track.

TABLE 1

| Pulse | Code | Size | Position |
|---|---|---|---|
| i0 | s0: ±1 | gT(0) | m0: 0, 8, 16, 24, 32, 40, 48, 56 |
| i1 | s1: ±1 | gT(1) | m1: 1, 9, 17, 25, 33, 41, 49, 57 |
| i2 | s2: ±1 | gT(2) | m2: 2, 10, 18, 26, 34, 42, 50, 58 |
| i3 | s3: ±1 | gT(3) | m3: 3, 11, 19, 27, 35, 43, 51, 59 |
| i4 | s4: ±1 | gT(4) | m4: 4, 12, 20, 28, 36, 44, 52, 60 |
| i5 | s5: ±1 | gT(5) | m5: 5, 13, 21, 29, 37, 45, 53, 61 |
| i6 | s6: ±1 | gT(6) | m6: 6, 14, 22, 30, 38, 46, 54, 62 |
| i7 | s7: ±1 | gT(7) | m7: 7, 15, 23, 31, 39, 47, 55, 63 |

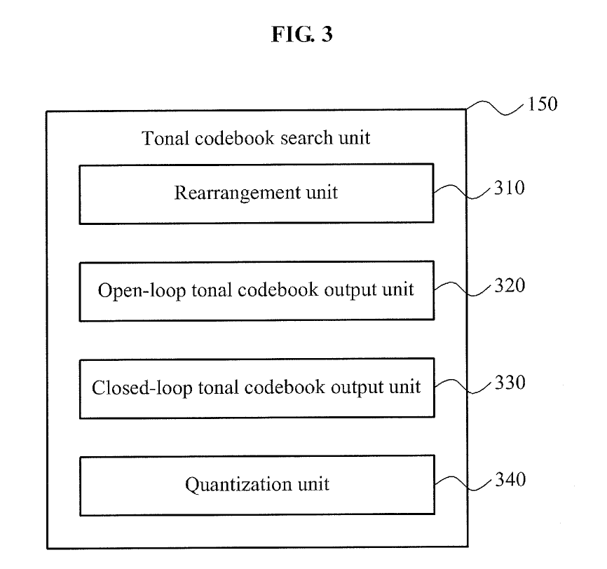

A detailed configuration and operation of the tonal codebook will be described with reference to FIG. 3.

The third spectrum transform unit 160 may output a third spectrum by transforming a layer signal obtained by decoding the low band signal bitstream output by the low band encoding unit 110. In detail, the third spectrum transform unit 160 may decode the low band signal bitstream output by the low band encoding unit 110 and MDCT and normalize the decoded measured signal, thereby transforming the low band signal bitstream into the third spectrum.

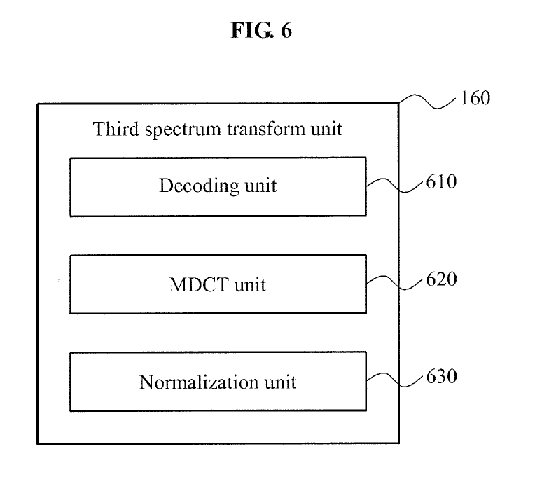

A detailed configuration and operation of the third spectrum transform unit 160 will be described with reference to FIG. 6.

The non-tonal codebook search unit 170 may search a non-tonal codebook that minimizes a difference between the third spectrum and a fourth spectrum. The third spectrum is LP synthesized by a non-tonal component including an aperiodic component of the input signal and the LP coefficient. The fourth spectrum is generated by removing a contribution of the tonal codebook from the first spectrum.

The non-tonal codebook search unit 170 may divide an entire band into a plurality of sub-bands to avoid an excessive amount of calculation caused by synthesis of the third spectrum, and may search for an open-loop non-tonal codebook delay, a closed-loop non-tonal codebook delay, and a gain with respect to each sub-band, accordingly reducing a search range. For example, when NQB is 64, the non-tonal codebook search unit 170 may divide the entire band into two sub-bands as shown in Table 2, to search for the open-loop non-tonal codebook delay of the non-tonal codebook.

TABLE 2

| Sub- | Sub- | Number of | | |
|---|---|---|---|---|
| band | band | sub-band | Lower boundary | Upper boundary |
| index | boundary | coefficients | of search range | of search range |
| j | bop(j) | Nop(j) | Lop(j) | Uop(j) |
| 0 | 0 | 32 | 0 | 32 |
| 1 | 32 | 32 | 0 | 32 |
| 2 | 64 | — | — | — |

In addition, when NQB is 64, the non-tonal codebook search unit 170 may divide the entire band into four sub-bands as shown in Table 3, to search for the closed-loop non-tonal codebook delay and the gain of the non-tonal codebook.

TABLE 3

| Sub- | Sub- | Number of | | |
|---|---|---|---|---|
| band | band | sub-band | Lower boundary | Upper boundary |
| index | boundary | coefficients | of search range | of search range |
| j | bcl(j) | Ncl(j) | Lcl(j) | Ucl(j) |
| 0 | 0 | 16 | [0≦] | Lagop(0) + [symbol] |
| | | | [symbol] ) − 8 | |
| 1 | 16 | 16 | Lagcl(0) + | Lagcl(0) + [symbol] 7 |
| | | | [symbol] 8 | |
| 2 | 32 | 16 | [0≦] | Lagop(1) + [symbol] |
| | | | [symbol] ) − 8 | |
| 3 | 48 | 16 | Lagcl(2) + | Lagcl(2) + [symbol] 7 |
| | | | [symbol] 8 | |
| 4 | 64 | — | — | — |

[symbol]

indicates data missing or illegible when filed

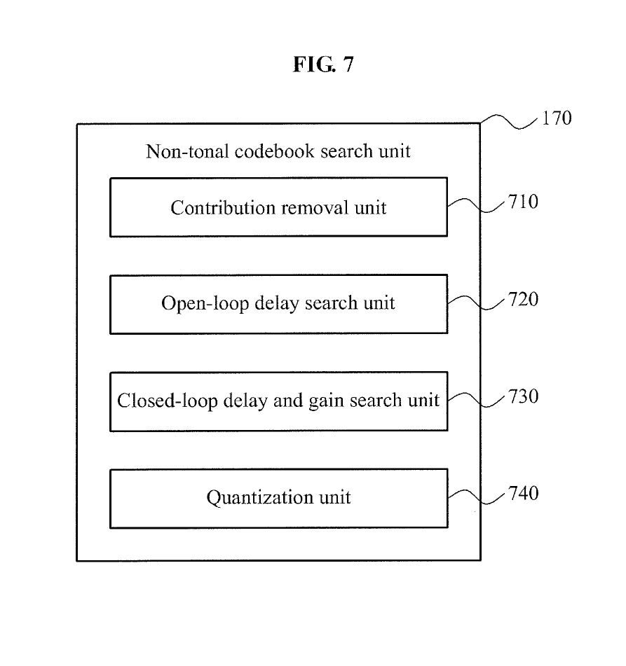

A detailed configuration and operation of the non-tonal codebook search unit 170 will be described with reference to FIG. 7.

The signal output unit 180 may output an encoded signal using the LP coefficient, the tonal codebook, and the non-tonal codebook. For example, the signal output unit 180 may be a multiplexer that multiplexes the low band signal bitstream output by the low band encoding unit 110, the LP coefficient bitstream, the tonal codebook, the non-tonal codebook, and a gain bitstream output during transformation the first spectrum by the first spectrum transform unit 120.

FIG. 2 is a diagram illustrating the first spectrum transform unit 120 according to an embodiment of the present invention.

Referring to FIG. 2, the first spectrum transform unit 120 according to the embodiment may include a high band spectrum transform unit 210, a low band spectrum transform unit 220, a spectrum combining unit 230, a gain output unit 240, and a normalization unit 250.

The high band spectrum transform unit 210 may transform a high band signal including an upper band of an input signal and output a high band spectrum. Here, the high band spectrum transform unit 210 may output a high band MDCT spectrum by performing MDCT with respect to the high band signal.

The low band spectrum transform unit 220 may perform MDCT with respect to a low band signal including a lower band of the input signal and output a low band spectrum. Here, the low band spectrum transform unit 220 may output a low band MDCT spectrum by performing MDCT with respect to the low band signal.

In detail, the low band spectrum transform unit 220 may recognize a band not encoded by the low band encoding unit 110 from the low band MDCT spectrum, and output a residual low band MDCT spectrum of the recognized band.

When an MDCT block is present in the low band encoding unit 110, the low band spectrum transform unit 220 may recognize an MDCT spectrum obtainable during decoding of the low band signal bitstream by the third spectrum transform unit 160. Next, the spectrum transform unit 220 may perform MDCT with respect to signals of only remaining bands except a band corresponding to the recognized MDCT spectrum, among the low band signals.

When the low band encoding unit 110 encodes all bands of the low band signals, the low band spectrum transform unit 220 may not operate.

The high band spectrum transform unit 210 and the low band spectrum transform unit 220 may perform MDCT with respect to signals of an input time domain, using Equation 3.

$$X ( k ) = {\sum }_{n = 0}^{2 N - 1} w ( n ) x ( n ) cos ( \frac{π}{N} ( n + \frac{1}{2} + \frac{N}{2} ) ( k + \frac{1}{2} ) ) , \\ k = 0 , 1 , … , ( N - 1 ) \qquad [ Equation 3 ]$$

Here, N denotes a length of a frame for processing the signals of the time domain in units of block, w(n) denotes a window function, and x(n) denotes the input signal. In addition, n denotes a time domain index and k denotes a frequency domain index.

The spectrum combining unit 230 may output a fifth spectrum by combining the high band spectrum and the low band spectrum. In detail, the spectrum combining unit 230 may output a quantized band MDCT spectrum, which is the fifth spectrum, by combining the high band MDCT spectrum and the residual low band MDCT spectrum.

The gain output unit 240 may output a quantized gain of the fifth spectrum. In detail, the gain output unit 240 may calculate a total gain of the fifth spectrum. Next, the gain output unit 240 may quantize the total gain of the fifth spectrum, and output the quantized gain and a gain bitstream.

For example, the quantized gain output by the gain output unit 240 may be calculated using Equation 4.

$${g}_{glob} = round ( {log}_{2} ( \sqrt{\frac{1}{{N}_{QB}} {\sum }_{k = 0}^{{N}_{{QB}^{- 1}}} {{X}_{QB} ( k )}^{2}} + {ɛ}_{rms} ) ) \\ {\hat{g}}_{glob} = {2}^{{g}_{glob}} \qquad [ Equation 4 ]$$

Here, round(•) denotes a function returning a nearest positive number, and arms denotes a value added to prevent an internal value of a log function from becoming zero. NQB denotes a number of the fifth spectrums. ĝ_{glob} denotes the quantized gain transformed into a linear domain.

The normalization unit 250 may normalize the fifth spectrum output by the spectrum combining unit 230 by the quantized gain output by the gain output unit 240, thereby outputting the first spectrum.

FIG. 3 is a diagram illustrating the tonal codebook search unit 150 according to an embodiment of the present invention.

Referring to FIG. 3, the tonal codebook search unit 150 may include a rearrangement unit 310, an open-loop tonal codebook output unit 320, a closed-loop tonal codebook output unit 330, and a quantization unit 340.

The rearrangement unit 310 may rearrange a sixth spectrum output by the filtering unit 140 according to a track structure for tonal codebook searching.

The open-loop tonal codebook output unit 320 may output the open-loop tonal codebook based on a size component related to the rearranged sixth spectrum.

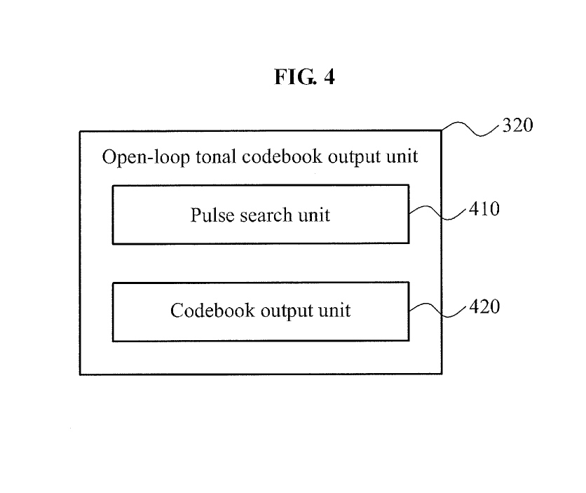

A detailed structure and operation of the open-loop tonal codebook output unit 320 will be described with reference to FIG. 4.

The closed-loop tonal codebook output unit 330 may search for a closed-loop tonal codebook using the open-loop tonal codebook the LP coefficient, and the first spectrum.

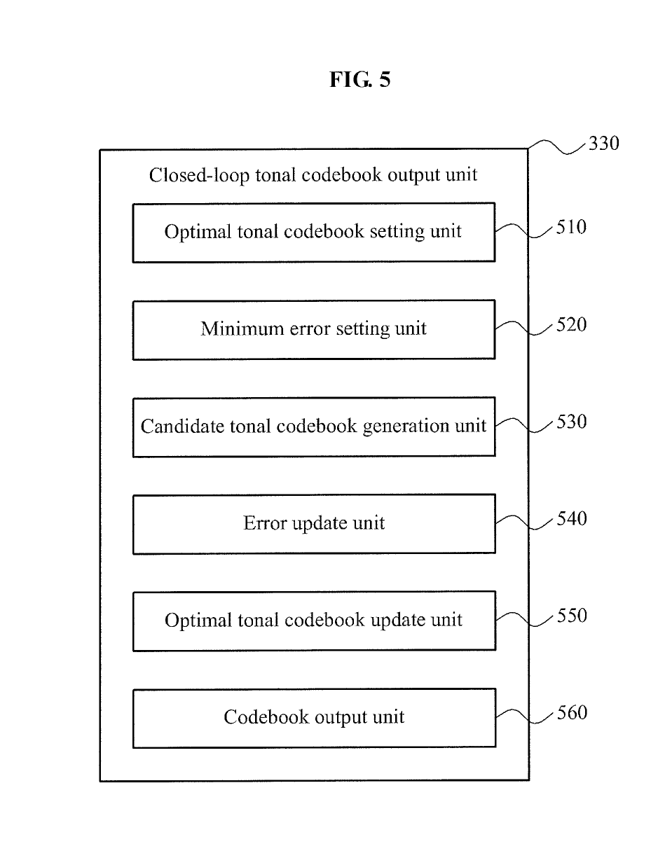

A detailed structure and operation of the closed-loop tonal codebook output unit 330 will be described with reference to FIG. 5.

The quantization unit 340 may quantize the closed-loop tonal codebook searched by the closed-loop tonal codebook search unit 330. Here, the quantization unit 340 may perform quantization by dividing each pulse of tracks constituting the tonal codebook into components including a position, a code, and a size.

In addition, the quantization unit 340 may calculate a contribution of the tonal codebook by setting the quantized closed-loop tonal codebook as an excitation signal and using the quantized LP coefficient. For example, the quantization unit 340 may calculate the contribution Y(k) of the tonal codebook using Equation 5. Here, Y(k) may denote a spectrum synthesized by inputting an open-loop tonal codebook T(k) formed by combining pulses of an entire track, and using the LP coefficient.

$$Y ( k ) = T ( k ) - {\sum }_{i = 1}^{6} {\hat{a}}_{i} Y ( k - i ) , k = 0 , … , 63 \qquad [ Equation 5 ]$$

FIG. 4 is a diagram illustrating an open-loop tonal codebook output unit 320 according to an embodiment of the present invention.

Referring to FIG. 4, the open-loop tonal codebook output unit 320 may include a pulse search unit 410 and a codebook output unit 420.

The pulse search unit 410 may search for a pulse having a largest absolute value corresponding to the size component with respect to a coefficient of the sixth spectrum rearranged according to the track structure. For example, the pulse search unit 410 may search for the pulse having the largest absolute value from each track shown in Table 1.

The codebook output unit 420 may generate an open-loop tonal codebook from the pulses found by the pulse search unit 410 and output the open-loop tonal codebook. For example, the codebook output unit 420 may generate the open-loop tonal codebook using Equation 6.

$${T}_{i} ( k ) = {s}_{i} δ ( k - {m}_{i} ) , i = 0 , … , 7 , k = 0 , … , 63 \\ T ( k ) = {\sum }_{i = 0}^{7} {g}_{T} ( i ) {T}_{i} ( k ) , k = 0 , … , 63 \qquad [ Equation 6 ]$$

Here, gT(i) denotes a pulse size of an i-th track, Ti(k) denotes a unit pulse of the i-th track, T(k) denotes an open-loop tonal codebook formed by combining pulses of the entire track, and δ(k) denotes a pulse in which k has a size of 1 in a position of 0.

FIG. 5 is a diagram illustrating a closed-loop tonal codebook output unit 330 according to an embodiment of the present invention.

Referring to FIG. 5, the closed-loop tonal codebook search unit 330 may include an optimal tonal codebook setting unit 510, a minimum error setting unit 520, a candidate tonal codebook generation unit 530, an error update unit 540, an optimal tonal codebook update unit 550, and a codebook output unit 560.

The optimal tonal codebook setting unit 510 may set the open-loop tonal codebook output by the open-loop tonal codebook output unit 320 as an initial value of the optimal tonal codebook. Here, the optimal tonal codebook setting unit 510 may synthesize the second spectrum by setting the optimal tonal codebook as an excitation signal and using the LP coefficient. For example, the optimal codebook setting unit 510 may synthesize the second spectrum by applying the quantized LP coefficient to Equation 5.

The minimum error setting unit 520 may set an error value of the first spectrum and the second spectrum as a minimum error value. For example, the minimum error setting unit 520 may calculate the error E of the first spectrum and the second spectrum using Equation 7, and initialize the error E to a minimum error value D*.

$$E = {\sum }_{k = 0}^{69} {\{ X ( k ) - Y ( k ) \}}^{2} \\ {D}^{*} = E \qquad [ Equation 7 ]$$

The candidate tonal codebook generation unit 530 may generate a candidate tonal codebook by substituting a pulse corresponding to a current track in a current optimal tonal codebook with a pulse corresponding to another position of a same track. Here, the candidate tonal codebook generation unit 530 may synthesize a seventh spectrum by setting the candidate tonal book as the excitation signal and using the LP coefficient. For example, the candidate tonal codebook generation unit 530 may synthesize the seventh spectrum using Equation 7.

The error update unit 540 may calculate a candidate error value of the first spectrum and the seventh spectrum generated by the candidate tonal codebook generation unit 530. Next, the error update unit 540 may update the minimum error value by comparing the candidate error value with the minimum error value set by the minimum error setting unit 520. In detail, when the candidate error value is smaller than the minimum error value, the error update unit 540 may update the minimum error value to the candidate error value.

When the error update unit 540 updates the minimum error value, the optimal tonal codebook update unit 550 may update the optimal tonal codebook using the candidate tonal codebook generated by the candidate tonal codebook generation unit 530.

Here, the candidate tonal codebook generation unit 530, the error update unit 540, and the optimal tonal codebook update unit 550 may update the error value and the optimal tonal codebook by generating the candidate tonal codebook with respect to all positions of the current track. In addition, when the error value and the optimal tonal codebook are updated in all positions of the current track, the candidate tonal codebook generation unit 530, the error update unit 540, and the optimal tonal codebook update unit 550 may update the error value and the optimal tonal codebook by generating the candidate tonal codebook in the aforementioned method in every track of Table 1.

The codebook output unit 560 may output the optimal tonal codebook updated by the optimal tonal codebook update unit 550 as the closed-loop tonal codebook. In detail, when update of the optimal tonal codebook is finished in every track of Table 1, the codebook output unit 560 may output the optimal tonal codebook being completely updated as the closed-loop tonal codebook.

FIG. 6 is a diagram illustrating the third spectrum transform unit 160 according to an embodiment of the present invention.

Referring to FIG. 6, the third spectrum transform unit 160 may include a decoding unit 610, an MDCT unit 620, and a normalization unit 630.

The decoding unit 610 may decode the low band signal bitstream output by the low band encoding unit 110, thereby outputting a quantized layer signal.

The MDCT unit 620 may perform MDCT with respect to the layer signal output by the decoding unit 610, thereby outputting the MDCT transformed layer signal.

The normalization unit 630 may output the third spectrum by normalizing the MDCT transformed layer signal.

FIG. 7 is a diagram illustrating the non-tonal codebook search unit 170 according to an embodiment of the present invention.

Referring to FIG. 7, the non-tonal codebook search unit 170 may include a contribution removal unit 710, an open-loop delay search unit 720, a closed-loop delay and gain search unit 730, and a quantization unit 740.

The contribution removal unit 710 may remove a contribution of the optimal tonal to codebook found by the tonal codebook search unit 150 from the first spectrum and the sixth spectrum. For example, the contribution removal unit 710 may remove the contribution Y*(k) of the optimal tonal codebook T*(k) calculated by the quantization unit 340 of the tonal codebook search unit 150 from XQB(k) which is the first spectrum, using Equation 8. In addition, the contribution removal unit 710 may remove the optimal tonal codebook T*(k) of the tonal codebook search unit 150 from R(k) which is the sixth spectrum using Equation 8.

X′_{QB}(k)= X̅_{QB}(k)−Y*(k),k=0, . . . ,63

R_{N}(k)=R(k)−T*(k),k=0, . . . ,63 [Equation 8]

The open-loop delay search unit 720 may search for the open-loop non-tonal codebook delay using the third spectrum and the sixth spectrum from which the contribution is removed.

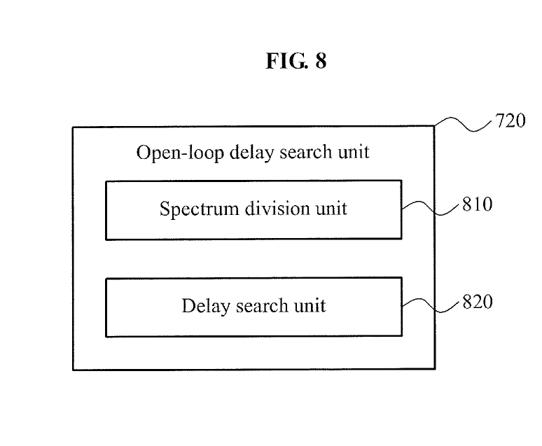

A detailed structure and operation of the open-loop delay search unit 720 will be described later with reference to FIG. 8.

The closed-loop delay and gain search unit 730 may search for the closed-loop non-tonal codebook delay and a gain using the third spectrum and the first spectrum from which the contribution is removed.

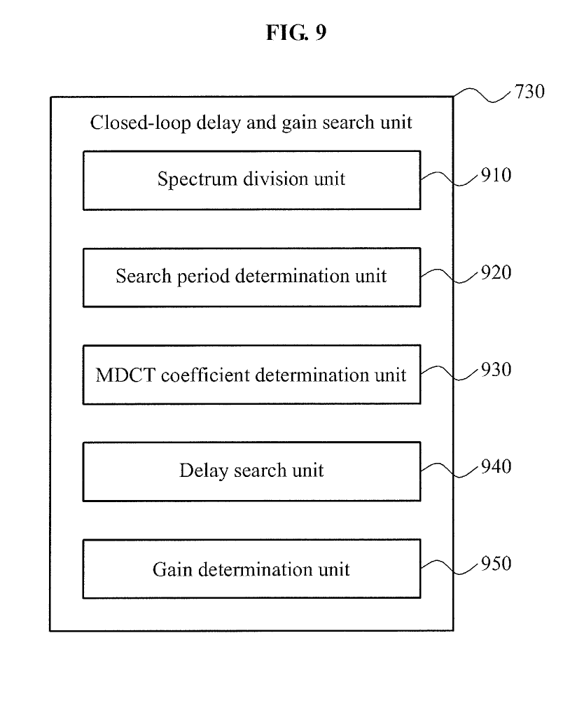

A detailed structure and operation of the closed-loop delay and gain search unit 730 will be described later with reference to FIG. 9.

FIG. 8 is a diagram illustrating the open-loop delay search unit 720 according to an embodiment of the present invention.

Referring to FIG. 8, the open-loop delay search unit 720 may include a spectrum division unit 810 and a delay search unit 820.

The spectrum division unit 810 may divide the contribution-removed sixth spectrum, according to a sub-band structure set for searching for the open-loop non-tonal codebook. For example, the spectrum division unit 810 may divide the contribution-removed first spectrum according to Table 2. Here, the spectrum division unit 810 may initialize a sub-band index indicating a current sub-band to zero.

The delay search unit 820 may search for a delay of which normalized correlation between the third spectrum and the contribution-removed sixth spectrum is largest in an open-loop search period corresponding, to the current sub-band of the sub-band divided by the spectrum division unit 810. For example, the delay search unit 820 may search the delay of which the normalized correlation between the third spectrum CB(k) and the contribution-removed sixth spectrum is largest, using Equation 9.

$${Lag}_{op} ( j ) = {arg max}_{{L}_{op} ( j ) \leq l < {U}_{op} ( j )} \{ \frac{{\sum }_{k = {b}_{ol} ( j )}^{{b}_{op} ( j + 1 ) - 1} {R}_{N} ( k ) {\overline{X}}_{CB} ( k + l )}{\sqrt{{\sum }_{k = {b}_{ol} ( j )}^{{b}_{op} ( j + 1 ) - 1} {\overline{X}}_{CB} ( k + l ) {\overline{X}}_{CB} ( k + l )}} \} , j = 0 , 1 \qquad [ Equation 9 ]$$

Here, when the delay is searched in the open-loop search period, the delay search unit 820 may determine whether the sub-bands divided by the spectrum division unit 810 includes a sub-band not searched for the delay. When the sub-band not searched for the delay is present, the delay search unit 820 may select the sub-band not searched for the delay as a current sub-band and search for the delay.

FIG. 9 is a diagram illustrating a closed-loop delay and gain search unit 730 according to an embodiment of the present invention.

Referring to FIG. 9, the closed-loop delay and gain search unit 730 may include a spectrum division unit 910, a search period determination unit 920, an MDCT coefficient determination unit 930, a delay search unit 940, and a gain determination unit 950.

The spectrum division unit 910 may divide the contribution-removed first spectrum according to a sub-band structure set for searching for the closed-loop non-tonal codebook. For example, the spectrum division unit 910 may divide the contribution-removed first spectrum according to Table 3. Here, the spectrum division unit 910 may initialize a sub-band index indicating a current sub-band to zero.

The search period determination unit 920 may determine a closed-loop search period according to the open-loop non-tonal codebook delay found by the open-loop delay search unit 720.

The MDCT coefficient determination unit 930 may set the third spectrum as the excitation signal in the closed-loop search period of the current sub-band, and determine an MDCT coefficient using the LP coefficient. Here, the MDCT coefficient may be a coefficient synthesized by applying the quantized LP coefficient to Equation 5.

In detail, the MDCT coefficient determination unit 930 may input a signal corresponding to each delay within the search range of the third spectrum instead of T(k) of Equation 5, and may determine the MDCT coefficient Zj(k+1) by synthesizing the spectrum using the LP coefficient.

The delay search unit 940 may search for the delay that minimizes an error between the MDCT coefficient and the quantized band coefficient in which the contribution of the tonal codebook is removed. Here, the quantized band coefficient may be a quantized band MDCT coefficient.

In detail, the delay search unit 940 may search for the delay that minimizes the error between the MDCT coefficient and the quantized band coefficient, using the LP coefficient quantized by setting the third spectrum as the excitation signal in the closed-loop search period in each sub-band.

For example, the delay search unit 940 may search for the delay that maximizes Equation 10.

$$\frac{{\sum }_{k = {b}_{cl} ( j )}^{{b}_{cl} ( j + 1 ) - 1} {X}_{QB}^{′} ( k ) {Z}_{j} ( k + l )}{\sqrt{{\sum }_{k = {b}_{cl} ( j )}^{{b}_{cl} ( j + 1 ) - 1} {Z}_{j} ( k + l ) {Z}_{j} ( k + l )}} , {L}_{cl} ( j ) \leq l < {U}_{cl} ( j ) , \\ j = 0 , 1 , 2 , 3 \qquad [ Equation 10 ]$$

Here, Zj(k+1) may denote the MDCT coefficient which is LP synthesized by setting the third spectrum of a j-th sub-band in a delay 1 as the excitation signal by the MDCT coefficient determination unit 930.

The gain determination unit 950 may determine a gain of the non-tonal codebook in the delay found by the delay search unit 940. For example, the gain determination unit 950 may determine the gain of the non-tonal codebook using Equation 10 in the found delay. In detail, the gain determination unit 950 may determine a gain between Zj(k+1) and X′QB(k) as the gain of the non-tonal codebook.

The gain determination unit 950 may generate the non-tonal codebook using the delay found by the delay search unit 940 and the gain determined by the gain determination unit 950, and may quantize and output the non-tonal codebook. A parameter of the non-tonal codebook may include the delay and the gain found in each closed-loop sub-band.

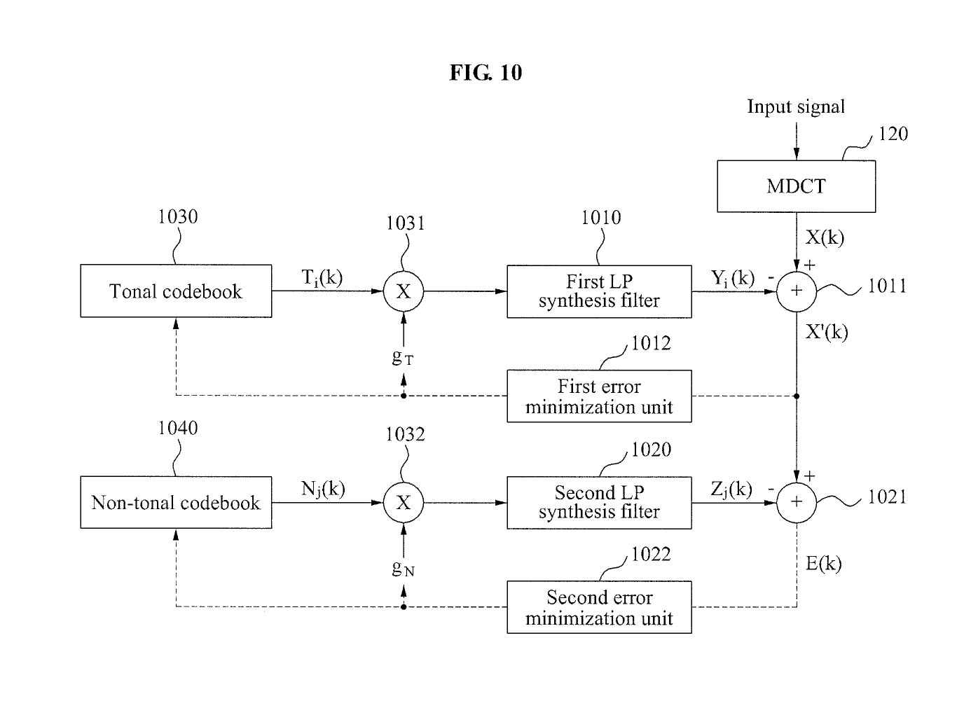

FIG. 10 is a diagram illustrating a process of searching for a tonal codebook and a non-tonal codebook, according to an embodiment of the present invention.

An MDCT unit 1000 may transform an input signal of a time domain into an MDCT spectrum X(k) of a frequency domain, using Equation 3. Here, the MDCT unit 1000 may be the first spectrum transform unit 120.

Next, the LP unit 130 may calculate the LP coefficient by applying LP analysis to the MDCT spectrum X(k) transformed by the MDCT unit 1000.

Next, the LP unit 130 may generate a first LP synthesis filter 1010 and a second LP synthesis filter 1020 for calculating a synthesized spectrum with respect to an excitation codebook from the LP coefficient. Here, the first LP synthesis filter 1010 and the second LP synthesis filter 1020 may have a same configuration.

Next, a first error minimization unit 1012 may search for a tonal codebook Ti(k) 1030 that minimizes an error of a spectrum Yi(k) LP synthesized by the MDCT spectrum X(k) and a tonal component combination, and search for a gain gT of the Ti(k). Here, the first error minimization unit 1012 may be the tonal codebook search unit 150. The first error minimization unit 1012 may calculate an error between each Yi(k) and an original spectrum X(k), and designate Yi(k) that generates a spectrum with a minimum error as an optimal spectrum Y*(k).

Next, the first LP synthesis filter 1010 may output the spectrum Yi(k) by LP synthesizing the tonal codebook Ti(k) 1030 and the gain gT.

Here, a target spectrum X′(k) to be found in a non-tonal codebook 1040 may be a spectrum from which the optimal spectrum Y*(k) is removed from the MDCT spectrum X(k).

Last, a second error minimization unit 1022 may search for a non-tonal codebook Ni(k) 1040 that minimizes an error of an LP spectrum Yj(k) synthesized by the target spectrum X′(k) and the non-tonal codebook, and search for a gain gx of the Ni(k). Here, the second error minimization unit 1022 may be the non-tonal codebook search unit 170.

In addition, a second LP synthesis filter 1020 may output a spectrum Zj(k) by LP synthesizing the non-tonal codebook Ni(k) 1040 and a gain gN.

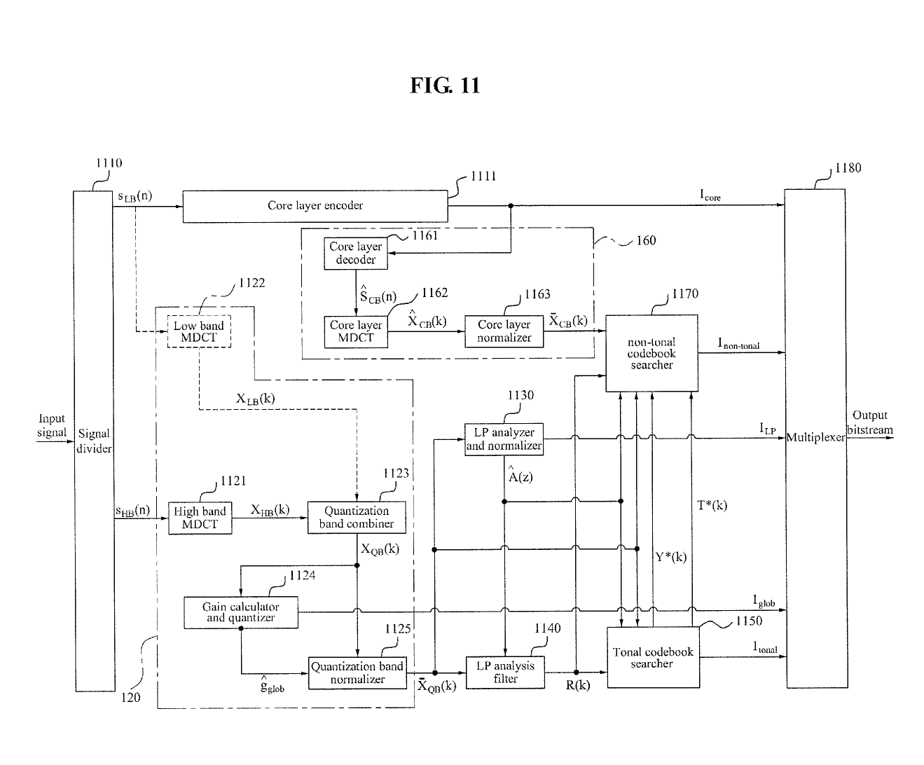

FIG. 11 is a diagram illustrating an encoding apparatus according to an embodiment of the present invention.

As shown in FIG. 11, the encoding apparatus may include a signal band divider 1110, a core layer encoder 1111, a high band MDCT 1121, a low band MDCT 1122, a quantized band combiner 1123, a gain calculator and quantizer 1124, a quantized band normalizer 1125, an LP analyzer and quantizer 1130, an LP analysis filter 1140, a tonal codebook searcher 1150, a core layer decoder 1161, a core layer MDCT 1162, a core layer normalizer 1163, a non-tonal codebook searcher 1170, and a multiplexer 1180.

1) The signal band divider 1110 may output an input signal by dividing the input signal into a low band signal SLB(n) which includes a lower band of the input signal and a high band signal SHB(n) which includes an upper band of the input signal. For example, the signal band divider 1110 may be an analysis quadrature mirror filter (QMF).

2) The core layer encoder 1111 may output a core layer bitstream Icore by encoding the low band signal SLB(n) output in 1) according to a predeterined core layer encoding algorithm. Here, the core layer encoder 1111 may be included in the low band encoding unit 110.

3) The high band MDCT 1121 may output a high band MDCT spectrum XHB(k) by performing MDCT with respect to the high band signal SHB(n) output in 1). In addition, the low band MDCT 1122 may output a residual low band MDCT spectrum X_{LB}^{re}(k) which the core layer encoder 1111 may not encode in 2), among low band MDCT spectrums generated by MDCT transforming the low band signal SLB(n) output in 1).

4) The quantized band combiner 1123 may output a quantized band MDCT spectrum XQB(k) by combining the high band MDCT spectrum XHB(k) output in 3) with the residual low band MDCT spectrum X_{LB}^{re}(k).

5) The gain calculator and quantizer 1124 may calculate and quantize a total gain of the quantized band MDCT spectrum XQB(k). Here, the gain calculator and quantizer 1124 may output the quantized gain ĝ_{glob} and a gain bitstream Iglob.

6) The quantized band normalizer 1125 may normalize the quantized band MDCT spectrum XQB(k) output in 4) to the gain ĝ_{glob} quantized in 5). Here, the quantized band normalizer 1125 may output the quantized band MDCT spectrum X̅_{QB}(k) being normalized.

Here, the high band MDCT 1121, the low band MDCT 1122, the quantized band combiner 1123, the gain calculator and quantizer 1124, and the quantized band normalizer 1125 may be included in the first spectrum transform unit 120. In addition, X̅_{QB}(k) may be the first spectrum.

7) The LP analyzer and quantizer 1130 may extract and quantize the LP coefficient by applying the LP analysis process to the quantized band MDCT spectrum X̅_{QB}(k) normalized in 6). The LP analyzer and quantizer 1130 may output a quantized LP coefficient Â(z) and a coefficient bitstream ILP. The LP analyzer and quantizer 1130 may be included in the LP unit 130.

8) The LP analysis filter 1140 may configure an LP analysis filter using the LP coefficient Â(z) quantized in 7). Next, the LP analysis filter 1140 may output an LP residual MDCT spectrum R(k) by filtering the quantized band MDCT spectrum X̅_{QB}(k) normalized in 6) by the configured LP analysis filter. Here, the LP analysis filter 1140 may be included in the filtering unit 140. The R(k) may be the sixth spectrum.

9) The tonal codebook searcher 1150 may search for the tonal codebook using the quantized band MDCT spectrum X̅_{QB}(k) normalized in 6), the LP residual MDCT spectrum R(k) filtered in 8), and the quantized LP coefficient Ā(z) quantized in 7). Here, the tonal codebook searcher 1150 may quantize the found tonal codebook, thereby outputting the quantized tonal codebook, T*(k) and the contribution Y*(k), and the tonal codebook bitstream Itonal. In addition, the tonal codebook searcher 1150 may be included in the tonal codebook search unit 150.

10) The core layer decoder 1161 may decode the core layer bitstream Icore encoed in 2) and output the quantized core layer signal ŝ_{CB}(n).

11) The core layer MDCT 1162 may perform MDCT with respect to the core layer signal ŝ_{CB}(n) quantized in 10) and output a core layer MDCT spectrum \hat{X}_{CB}(k) 351.

12) The core layer normalizes 1163 may normalize the core layer MDCT spectrum \hat{X}_{CB}(k) output in 11) and output the normalized core layer MDCT spectrum X̅_{CB}(k).

Here, the core layer decoder 1151, the core layer MDCT 1162, and the core layer normalizer 1163 may be included in the third spectrum transform unit 160. In addition, the X̅_{QB}(k) may be the third spectrum.

13) The non-tonal codebook searcher 1170 may search for the non-tonal codebook, using the core layer MDCT spectrum X̅_{CB}(k) normalized in 12), the quantized band MDCT spectrum X̅_{QB}(k) normalized in 6), the LP residual MDCT spectrum R(k) filtered in 8), the LP coefficient Â(z) quantized in 7), the tonal codebook quantized in 9), and the T*(k) and the contribution Y*(k). Here, the non-tonal codebook searcher 1170 may output the non-tonal codebook bitstream Inon-tonal by quantizing the non-tonal codebook being found. The non-tonal codebook searcher 1170 may be included in the non-tonal codebook search unit 170.

14) The multiplexer 1180 may generate the an output bitstream by multiplexing the core layer bitstream Icore encoded in 2), the gain bitstream Iglob output in 5), the LP coefficient bitstream ILP output in 7), the tonal codebook bitstream Itonal output in 9), and the non-tonal codebook bitstream Inon-tonal output in 13). Here, the multiplexer 1180 may be included in the signal output unit 180.

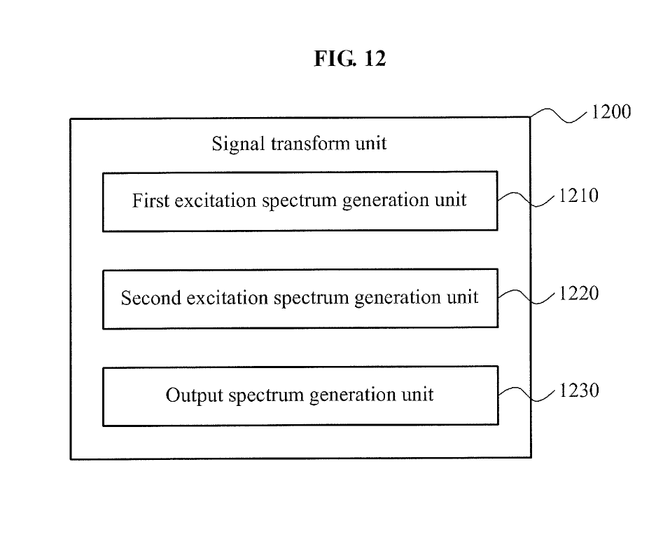

FIG. 12 is a diagram illustrating a signal transform unit 1200 according to an embodiment of the present invention.

Referring to FIG. 12, the signal transform unit 1200 may include a first excitation spectrum generation unit 1210, a second excitation spectrum generation unit 1220, and an output spectrum generation unit 1230.

The first excitation spectrum generation unit 1210 may generate a first excitation spectrum using a tonal excitation spectrum according to an input signal and a gain of the tonal excitation spectrum. Here, the tonal excitation spectrum may include a periodic component of the input signal and may be expressed as a combination of impulses with respect to respective tonal components.

In detail, the first tonal components spectrum generation unit 1210 may generate the first excitation spectrum by multiplying the tonal excitation spectrum by the gain of the tonal excitation spectrum.

The second excitation spectrum generation unit 1220 may generate a second excitation spectrum using a non-tonal excitation spectrum according to the input signal and a gain of the non-tonal excitation spectrum. Here, the non-tonal excitation spectrum may include an aperiodic component of the input signal and may be expressed as a noise.

In detail, the second excitation spectrum generation unit 1220 may generate the second excitation spectrum by multiplying the non-tonal excitation spectrum by the gain of the non-tonal excitation spectrum.

The output spectrum generation unit 1230 may generate an output spectrum using the first excitation spectrum generated by the first excitation spectrum generation unit 1210 and the second excitation spectrum generated by the second excitation spectrum generation unit 1220.

In detail, the output spectrum generation unit 1230 may generate the output spectrum by synthesizing a result of adding the first excitation spectrum and the second excitation spectrum through a source filter. Here, the source filter may be an LP synthesis filter. For example, the source filter may generate the output spectrum using Equation 11.

$$\frac{1}{A ( z )} = \frac{1}{1 + {\sum }_{i = 1}^{p} {a}_{i} {z}^{- i}} \qquad [ Equation 11 ]$$

Here, aᵢ, i=1, . . . , p denotes the LP coefficient and p denotes an LP degree.

The high band MDCT 1121, the low band MDCT 1122, and the core layer MDCT 1162 of FIG. 11 may include the same configuration as the signal transform unit 1200.

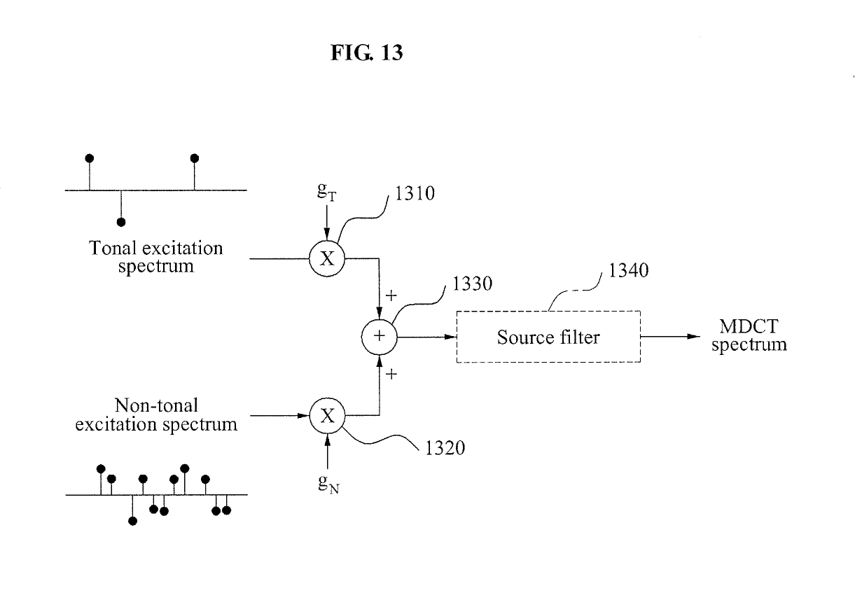

FIG. 13 is a diagram illustrating a source filter 1340 that outputs an MDCT spectrum, according to an embodiment of the present invention.

A first calculator 1310 included in the first excitation spectrum generation unit 1210 may generate the first excitation spectrum by multiplying the tonal excitation spectrum by the gain of the tonal excitation spectrum.

A second calculator 1320 included in the second excitation spectrum generation unit 1220 may generate the second excitation spectrum by multiplying the non-tonal excitation spectrum by the gain of the non-tonal excitation spectrum.

A third calculator 1330 included in the output spectrum generation unit 1230 may add the first excitation spectrum and the second excitation spectrum and may input the adding result to the source filter 1340.

The source filter 1340 may generate the output spectrum by synthesizing the spectrum received from the third calculator 1330. Here, the source filter may be an LP filter.

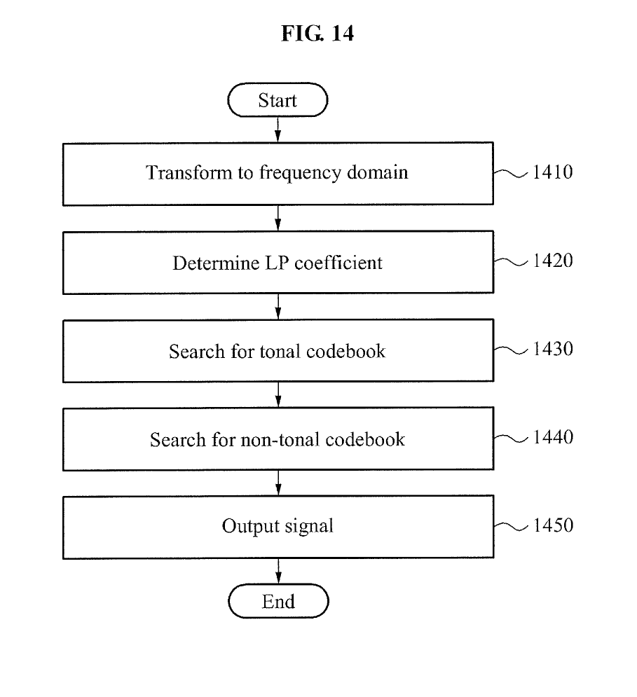

FIG. 14 is a flowchart illustrating a frequency spectrum processing method according to an embodiment of the present invention.

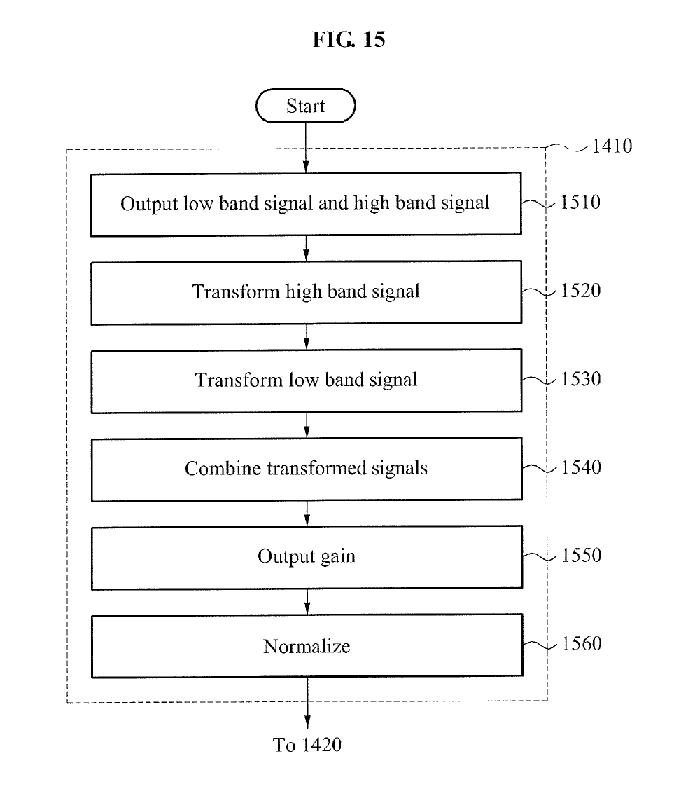

In operation 1410, the first spectrum transform unit 120 may transform an input signal of a time domain into a first spectrum of a frequency domain. The process of transforming the first input signal into the first spectrum will be described in detail with reference to FIG. 15.

In operation 1420, the LP unit 130 may determine an LP coefficient by LP analyzing the first spectrum transformed in operation 1410. Here, the LP unit 130 may quantize the LP coefficient determined by LP analyzing the first spectrum, and output the quantized LP coefficient and an LP coefficient bitstream corresponding to a quantization index of the LP coefficient.

In operation 1430, the tonal codebook search unit 150 may search for a tonal codebook that minimizes a difference between a second spectrum and the first spectrum using a track structure. Here, the second spectrum may be a spectrum which is LP synthesized by a tonal component including a periodic component of the input signal and the LP coefficient determined in operation 1420.

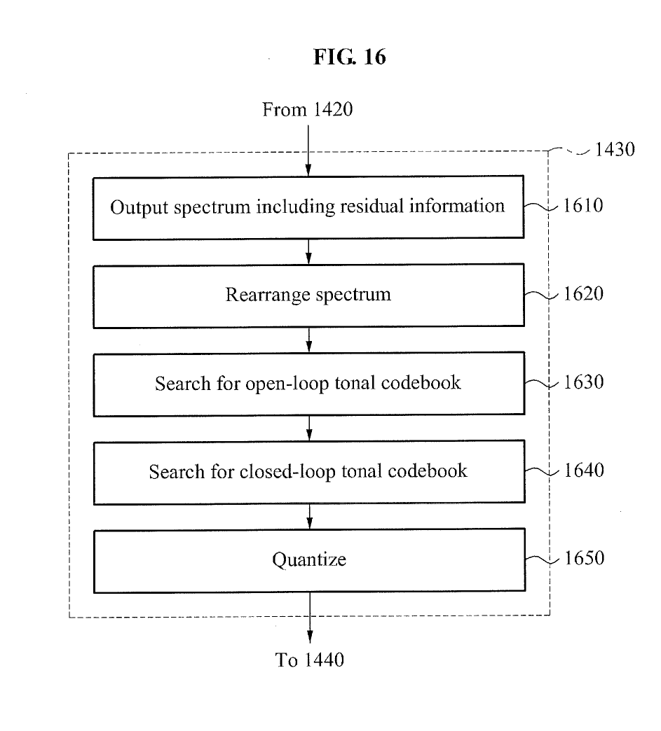

The process of searching for the tonal codebook will be described in detail with reference to FIG. 16.

In operation 1440, the non-tonal codebook search unit 170 may search for a non-tonal codebook that minimizes a difference between a third spectrum LP synthesized by a non-tonal component including an aperiodic component of the input signal and the LP coefficient determine in operation 1420 and a fourth spectrum generated by removing a contribution of the tonal codebook from the first spectrum transformed in operation 1410.

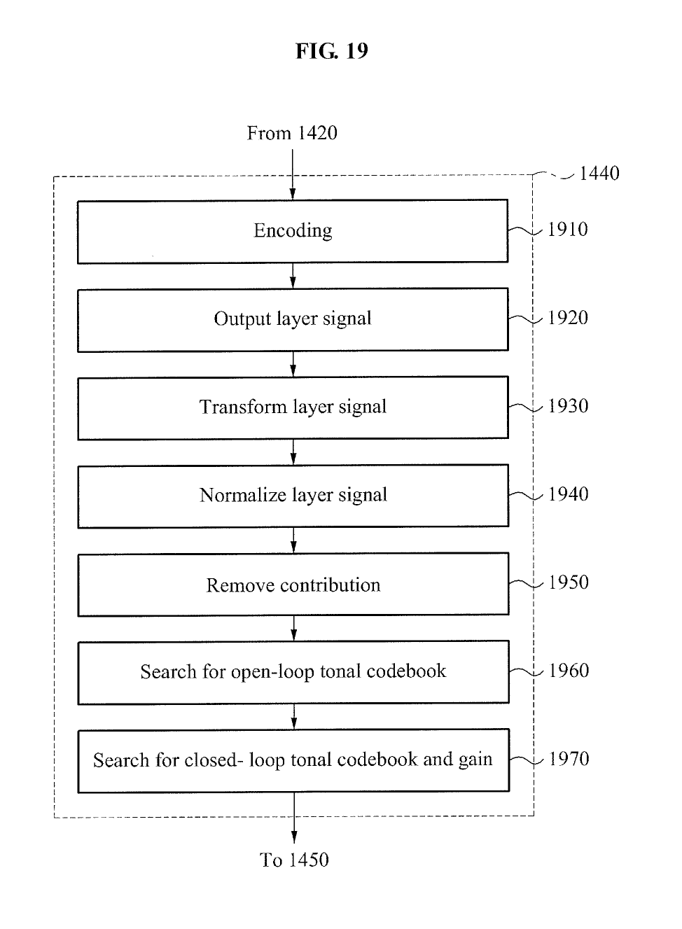

The process of search for the non-tonal codebook will be described in detail with reference to FIG. 19.

In operation 1450, the signal output unit 180 may output the encoded signal using the LP coefficient determined in operation 1420, the tonal codebook found in operation 1430, and the non-tonal codebook found in operation 1440.

FIG. 15 is a flowchart illustrating a spectrum transform method according to an embodiment of the present invention. Operations 1510 to 1560 of FIG. 15 may be included in operation 1410 of FIG. 14.

In operation 1510, the signal band divider 1110 may output the input signal by dividing the input signal into a low band signal which includes a lower band of the input signal and a high band signal which includes an upper band of the input signal.

In operation 1520, the high band spectrum transform unit 210 may output a high band spectrum by transforming the high band signal output in operation 1510. Here, the high band spectrum transform unit 210 may output a high band MDCT spectrum by performing MDCT with respect to the high band signal.

The operation 1530, the low band spectrum transform unit 220 may output a low band spectrum by performing MDCT with respect to the low band signal output in operation 1510. Here, the low band spectrum transform unit 220 may output a low band MDCT spectrum by performing MDCT with respect to the low band signal.

In detail, the low band spectrum transform unit 220 may recognize a band not encoded by the low band encoding unit 110 from the low band MDCT spectrum, and output a residual low band MDCT spectrum of the recognized band.

In operation 1540, the spectrum combiner 230 may output a fifth spectrum by combining the high band spectrum transformed in operation 1520 and the low band spectrum transformed in operation 1530.

In operation 1550, the gain output unit 240 may out a quantized gain of the fifth spectrum output in operation 1540. In detail, the gain output unit 240 may calculate a total gain of the fifth spectrum. Next, the gain output 240 may quantize the total gain of the fifth spectrum and output the quantized gain and a gain bitstream.

In operation 1560, the normalization unit 250 may normalize the fifth spectrum output in operation 1540 by the quantized gain output in operation 1550, thereby outputting the first spectrum.

FIG. 16 is a flowchart illustrating a tonal codebook search method according to an embodiment of the present invention. Operations 1610 to 1650 of FIG. 16 may be included in operation 1430 of FIG. 14.

In operation 1610, the filtering unit 140 may filter the first spectrum by an LP coefficient and thereby output a sixth spectrum including residual information according to the LP coefficient.

In detail, the filtering unit 140 may configure an LP analysis filter quantized by the LP unit 130, and output the sixth spectrum by filtering the first spectrum by the LP analysis filter.

In operation 1620, the rearrangement unit 310 may rearrange the sixth spectrum output in operation 1610 according to the track structure for searching for the tonal codebook.

In operation 1630, the open-loop tonal codebook output unit 320 may output the open-loop tonal codebook based on a size component with respect to the sixth spectrum rearranged in operation 1620.

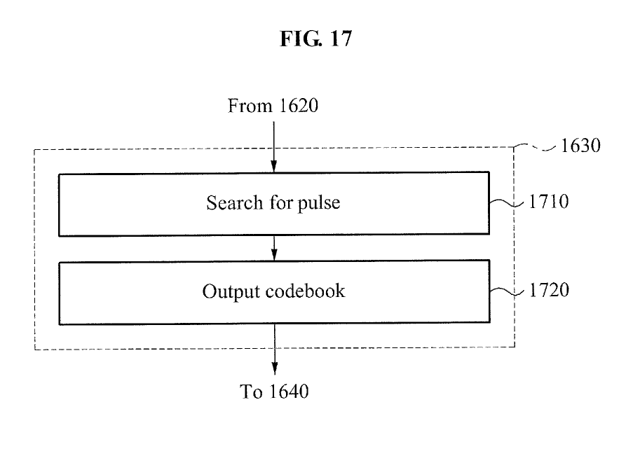

The process of outputting the open-loop tonal codebook will be described in detail with reference to FIG. 17.

In operation 1640, the closed-loop tonal codebook search unit 330 may search for the open-loop tonal codebook output in operation 1630, and search for the closed-loop tonal codebook using the LP coefficient determined in operation 1420 and the first spectrum transformed in operation 1410.

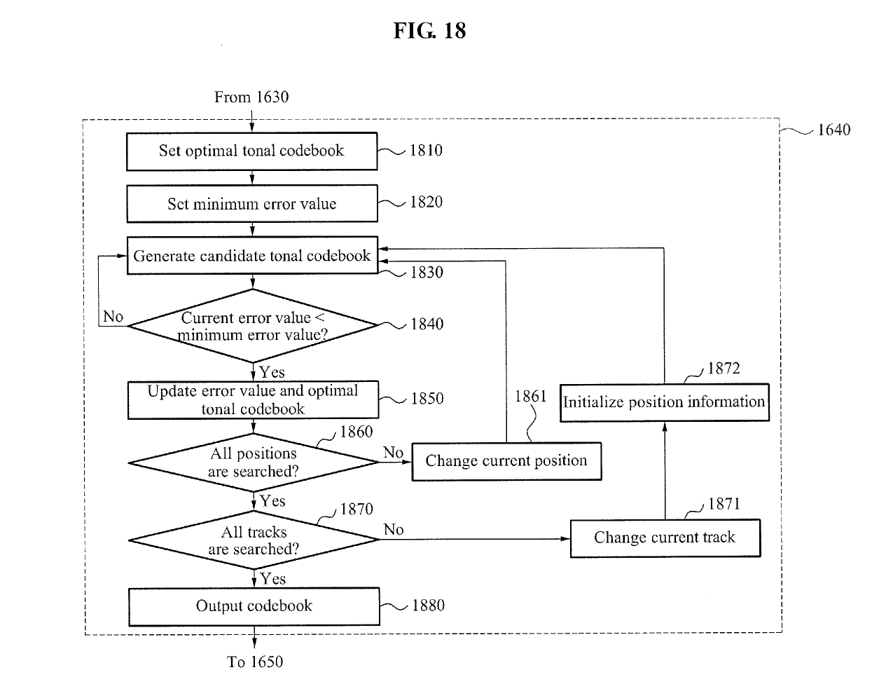

The process of search for the closed-loop tonal codebook will be described in detail with reference to FIG. 18.

In operation 1650, the quantization unit 340 may quantize the closed-loop tonal codebook found in operation 1640. Here, the quantization unit 340 may perform quantization by dividing each pulse of tracks constituting the tonal codebook into components including a position, a code, and a size.

Also, the quantization unit 340 may calculate a contribution of the tonal codebook by setting the quantized closed-loop tonal codebook as an excitation signal and using the quantized LP coefficient.

FIG. 17 is a flowchart illustrating an open-loop tonal codebook output method according to an embodiment of the present invention. Operations 1710 to 1720 of FIG. 17 may be included in operation 1630 of FIG. 16.

In operation 1710, the pulse search unit 410 may search for a pulse having a largest absolute value corresponding to the size component of with respect to a coefficient of the sixth spectrum rearranged according to the track structure. For example, the pulse search unit 410 may search for the pulse having the largest absolute value from each track shown in Table 1.

In operation 1720, the codebook output unit 420 may generate an open-loop tonal codebook from the pulses found in operation 1710 and output the open-loop tonal codebook. For example, the codebook output unit 420 may generate the open-loop tonal codebook using Equation 6.

FIG. 18 is a flowchart illustrating a closed-loop tonal codebook output method according to an embodiment of the present invention. Operations 1810 to 1880 of FIG. 18 may be included in operation 1640 of FIG. 16.

In operation 1810, the optimal tonal codebook setting unit 510 may set the open-loop tonal codebook output by the open-loop tonal codebook output unit 320 as an initial value of the optimal tonal codebook. Here, the optimal tonal codebook setting unit 510 may synthesize the second spectrum by setting the optimal tonal codebook as an excitation signal and using the LP coefficient.

In operation 1820, the minimum error setting unit 520 may set an error value of the first spectrum and the second spectrum as the initial error value.

In operation 1830, the candidate tonal codebook generation unit 530 may generate a candidate tonal codebook by substituting a pulse corresponding to a current track in the optimal tonal codebook set in operation 1810 with a pulse corresponding to a current position of a same track. Here, the candidate tonal codebook generation unit 530 may synthesize a seventh spectrum by setting the candidate tonal book as the excitation signal and using the LP coefficient.

Here, the error update unit 540 may calculate a candidate error value of the first spectrum and the seventh spectrum generated by the candidate tonal codebook generation unit 530.

In operation 1840, the error update unit 540 may determine whether the candidate error value calculated in operation 1830 is smaller than a current minimum error value.

When the candidate error value is not smaller than the minimum error value, the error update unit 540 may not update the error value but perform operation 1830.

When the candidate error value is smaller than the minimum error value, the error update unit 540 may perform operation 1850.

In operation 1850, the error update unit 540 may update the current minimum error value to the candidate error value calculated in operation 1830. In addition, the optimal tonal codebook update unit 550 may update the optimal tonal codebook using the candidate tonal codebook generated in operation 1830.

In operation 1860, the candidate tonal codebook generation unit 530 may check whether every position of the current track is searched. Here, when the every position of the current track is searched for the candidate tonal codebook, the candidate tonal codebook generation unit 530 may determine that all positions of the current track are searched.

When the all positions of the current track are not searched, the candidate tonal codebook generation unit 530 may change the current position in operation 1861.

In operation 1870, the candidate tonal codebook generation unit 530 may check whether all tracks are searched. Here, when the candidate tonal codebook is found in all the tracks, the candidate tonal codebook generation unit 530 may determine that the all the tracks are searched.

When not all the tracks are searched, the candidate tonal codebook generation unit 530 may change a current track to be searched in operation 1871. The current position to generate the candidate tonal codebook in the changed track may be different from an initially set position.

Therefore, in operation 1872, the candidate tonal codebook generation unit 530 may initialize position information of the current position.

When it is determined that all the tracks are searched in operation 1870, the codebook output unit 560 may perform operation 1880.

In operation 1880, the codebook output unit 560 may output the optimal tonal codebook updated in operation 1850 as the closed-loop tonal codebook.

FIG. 19 is a flowchart illustrating a non-tonal codebook search method according to an embodiment of the present invention. Operations 1910 to 1970 of FIG. 19 may be included in operation 1440 of FIG. 14.

In operation 1910, the low band encoding unit 110 may output a low band signal bitstream by encoding the low band signal output in operation 1510. In detail, the low band encoding unit 110 may output the low band signal bitstream by encoding the low band signal 330 according to a predetermined encoding algorithm.

In operation 1920, the encoding unit 610 may output a quantized layer signal by decoding the low band signal bitstream output in operation 1910.

In operation 1930, the MDCT unit 620 may output an MDCT transformed layer signal by performing MDCT with respect to the layer signal output in operation 1920.

In operation 1940, the normalization unit 630 may output a third spectrum by normalizing the layer signal MDCT transformed in operation 1930.

In operation 1950, the contribution removal unit 710 may remove a contribution of the tonal codebook from the first spectrum and the sixth spectrum. Here, the contribution of the tonal codebook may be the contribution calculated in operation 1650.

In operation 1960, the open-loop delay search unit 720 may search for an open-loop non-tonal codebook delay using the third spectrum output in operation 1940 and the sixth spectrum from which the contribution is removed in operation 1950.

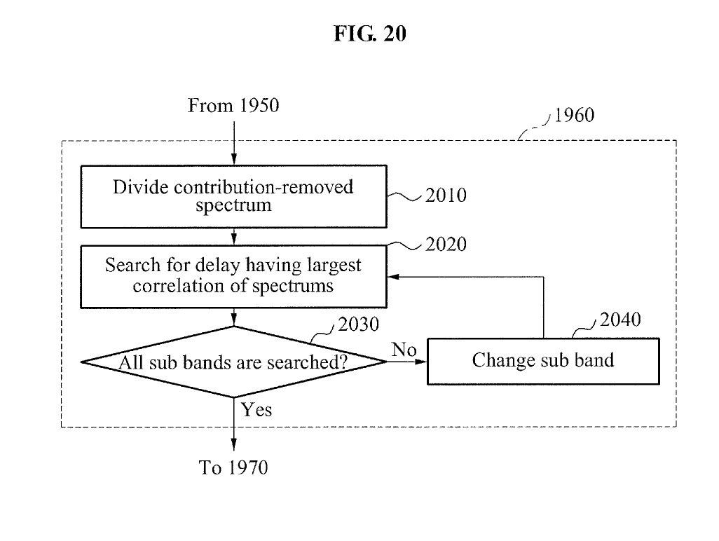

The process of searching for the open-loop non-tonal codebook delay will be described in detail with reference to FIG. 20.

In operation 1970, the closed-loop delay and gain search unit 730 may search for a closed-loop non-tonal codebook delay and a gain using the third spectrum output in operation 1940 and the first spectrum from which the contribution is removed in operation 1950.

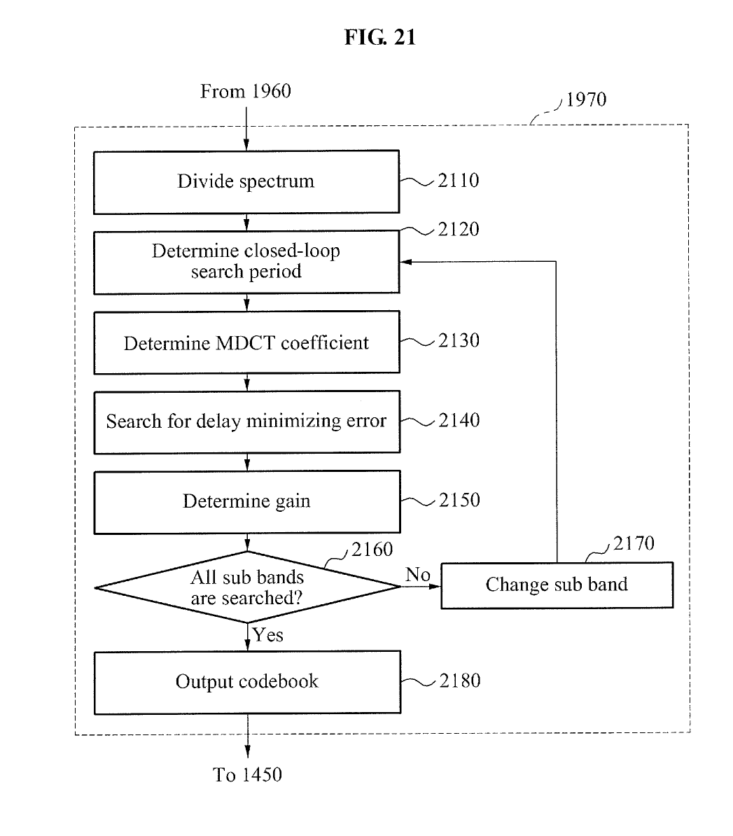

The process of searching for the closed-loop non-tonal codebook delay and the gain will be described in detail with reference to FIG. 21.

FIG. 20 is a flowchart illustrating an open-loop delay search method according to an embodiment of the present invention. Operations 2010 to 2040 of FIG. 20 may be included in operation 1960 of FIG. 19.

In operation 2010, the spectrum division unit 810 may divide a contribution-removed sixth spectrum, according to a sub-band structure set for searching for an open-loop non-tonal codebook. Here, the spectrum division unit 810 may initialize a sub-band index indicating a current sub-band to zero.

In operation 2020, the delay search unit 820 may search for a delay of which normalized correlation between the third spectrum and the contribution-removed sixth spectrum is largest in an open-loop search period corresponding to the current sub-band of the sub-band divided in operation 2010.

In operation 2030, the delay search unit 820 may determine whether the sub-bands divided in operation 2010 include a delay not searched for a delay.

When delays are found in all sub-bands, the delay search unit 820 may finish the open-loop delay searching.

When the sub-band not searched for the delay is present, the delay search unit 820 may perform operation 2040.

In operation 2040, the delay search unit 810 may change the sub-band not searched for the delay to the current sub-band and search for the delay by performing operation 2020.

FIG. 21 is a flowchart illustrating a closed-loop delay search method according to an embodiment of the present invention. Operations 2110 to 2180 of FIG. 21 may be included in operation 1970 of FIG. 19.

In operation 2110, the spectrum division unit 910 may divide the contribution-removed first spectrum according to a sub-band structure set for searching for the closed-loop non-tonal codebook. Here, the spectrum division unit 910 may initialize a sub-band index indicating a current sub-band to zero.

In operation 2120, the search period determination unit 920 may determine a closed-loop search period according to the open-loop non-tonal codebook delay found in operation 1960.

In operation 2130, the MDCT coefficient determination unit 930 may set the third spectrum as the excitation signal in the closed-loop search period of the current sub-band, and determine an MDCT coefficient using the LP coefficient.

In operation 2140, the delay search unit 940 may search for the delay that minimizes an error between the quantized band coefficient in which the contribution of the tonal codebook is removed and the MDCT coefficient determined in operation 2130. Here, the quantized band coefficient may be a quantized band MDCT coefficient.

In detail, the delay search unit 940 may search for the delay that minimizes the error between the MDCT coefficient and the quantized band coefficient, using an LP coefficient quantized by setting the third spectrum as the excitation signal in a closed-loop search period of each sub-band.

In operation 2150, the gain determination unit 950 may determine a gain of a non-tonal codebook in the delay found by the delay search unit 940.

In operation 2160, the delay search unit 940 may determine whether the sub-bands divided in operation 2110 includes a sub-band not searched for the delay.

When the delay is found in all sub-bands, the delay search unit 940 may perform operation 2180. When the sub-band not searched for the delay is present, the gain determination unit 950 may perform operation 2170.

In operation 2170, the delay search unit 940 may change the sub-band not searched for the delay to the current sub-band and search for the delay by performing operation 2020.

In operation 2180, the gain determination unit 950 may generate a non-tonal codebook using the delay found in operation 2140 and the gain determined in operation 2150, and quantize and output the generated non-tonal codebook.

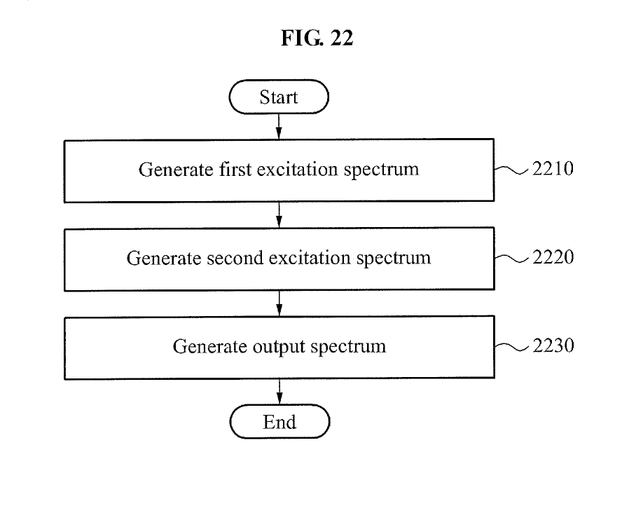

FIG. 22 is a flowchart illustrating an output spectrum generation method according to an embodiment of the present invention.

In operation 2210, the first excitation spectrum generation unit 1210 may generate a first excitation spectrum using a tonal excitation spectrum according to an input signal and a gain of the tonal excitation spectrum. In detail, the first excitation spectrum generation unit 1210 may generate the first excitation spectrum by multiplying the tonal excitation spectrum by the gain of the tonal excitation spectrum.

In operation 2220, the second excitation spectrum generation unit 1220 may generate a second excitation spectrum using a non-tonal excitation spectrum according to the input signal and a gain of the non-tonal excitation spectrum. Here, the second excitation spectrum generation unit 1220 may generate the second excitation spectrum by multiplying the non-tonal excitation spectrum by the gain of the non-tonal excitation spectrum.

In operation 2230, the output spectrum generation unit 1230 may generate an output spectrum using the first excitation spectrum generated in operation 2210 and the second excitation spectrum generated in operation 2220.

In detail, the output spectrum generation unit 1230 may generate the output spectrum by synthesizing an adding result of the first excitation spectrum and the second excitation spectrum through a source filter. The source filter may be an LP filter.

According to the embodiment of the present invention, a spectrum distortion may be reduced by expressing an MDCT spectrum by a source filter model including a linear predictor, a tonal codebook and a non-tonal codebook.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A frequency spectrum processing apparatus comprising:
a first excitation spectrum generation unit to generate a first excitation spectrum using a tonal excitation spectrum according to an input signal and a gain of the tonal excitation spectrum;
a second excitation spectrum generation unit to generate a second excitation spectrum using a non-tonal excitation spectrum according to the input signal and a gain of the non-tonal excitation spectrum; and
an output spectrum generation unit to generate an output spectrum using the first excitation spectrum and the second excitation spectrum.

2. The frequency spectrum processing apparatus of claim 1, wherein
the tonal excitation spectrum includes a periodic component of the input signal, and
the non-tonal excitation spectrum includes an aperiodic component of the input signal.

3. A frequency spectrum processing apparatus comprising:
a first spectrum transform unit to transform an input signal of a time domain into a first spectrum of a frequency domain;
a linear prediction (LP) unit to determine an LP coefficient by LP analyzing the first spectrum;
a tonal codebook search unit to search a tonal codebook that minimizes a difference between a second spectrum, the second spectrum which is LP synthesized by a tonal component including a periodic component of the input signal and the LP coefficient, and the first spectrum;
a non-tonal codebook search unit to search a non-tonal codebook that minimizes a difference between a third spectrum, the third spectrum which is LP synthesized by a non-tonal component including an aperiodic component of the input signal and the LP coefficient, and a fourth spectrum generated by removing a contribution of the tonal codebook from the first spectrum; and
a signal output unit to output an encoded signal using the LP coefficient, the tonal codebook, and the non-tonal codebook.

4. The frequency spectrum processing apparatus of claim 3, wherein the first spectrum transform unit comprises:
a gain output unit to output a quantized gain of a fifth spectrum generated using a high band spectrum formed by transforming a high band signal that includes an upper band of the input signal and a low band spectrum formed by transforming a low band signal that includes a lower band of the input signal; and
a normalization unit to output the first spectrum by normalizing the fifth spectrum by the quantized gain.

5. The frequency spectrum processing apparatus of claim 3, further comprising:
a filtering unit to output a sixth spectrum including residual information according to the LP coefficient by filtering the first spectrum by the LP coefficient.

6. The frequency spectrum processing apparatus of claim 5, wherein the tonal codebook search unit comprises:
a rearrangement unit to rearrange the sixth spectrum according to a track structure for searching for the tonal codebook;
an open-loop tonal codebook output unit to output an open-loop tonal codebook based on a size component with respect to the rearranged sixth spectrum; and
a closed-loop tonal codebook search unit to search for a closed-loop tonal codebook using the open-loop tonal codebook, the LP coefficient, and the first spectrum.

7. The frequency spectrum processing apparatus of claim 6, wherein the open-loop tonal codebook output unit comprises:
a pulse search unit to search for a pulse having a largest absolute value corresponding to the size component with respect to a coefficient of the sixth spectrum rearranged according to the track structure; and
a codebook output unit to generate and output the open-loop tonal codebook using found pulses.

8. The frequency spectrum processing apparatus of claim 6, wherein the closed-loop tonal codebook search unit comprises:
an optimal tonal codebook setting unit to set the open-loop tonal codebook as an optimal tonal codebook;
a minimum error setting unit to set an error value of the first spectrum and the second spectrum as a minimum error value;
a candidate tonal codebook generation unit to generate a candidate tonal codebook by substituting a pulse corresponding to a current track in the optimal tonal codebook with a pulse corresponding to a current position of a same track;
an error update unit to update the optimal tonal codebook using the candidate tonal codebook when the minimum error value is updated; and
a codebook output unit to output the updated optimal tonal codebook to the closed-loop tonal codebook.

9. The frequency spectrum processing apparatus of claim 6, further comprising:
a quantization unit to divide each pulse of tracks constituting the tonal codebook into components including a position, a code, and a size and quantize each of the components.

10. The frequency spectrum processing apparatus of claim 5, further comprising:
a low band encoding unit to output a low band signal bitstream by encoding a low band signal including a lower band of the input signal; and
a third spectrum transform unit to output a third spectrum by transforming a layer signal obtained by decoding the low band signal transform.

11. The frequency spectrum processing apparatus of claim 10, wherein the third spectrum transform unit comprises:
a decoding unit to output the quantized layer signal by decoding the low band signal bitstream;
a modified discrete cosine transform (MDCT) unit to MDCT and output the layer signal; and
a normalization unit to output the third spectrum by normalizing the layer signal.

12. The frequency spectrum processing apparatus of claim 3, wherein the non-tonal codebook search unit comprises:
a contribution to remove a contribution of the tonal codebook from the first spectrum and the sixth spectrum;
an open-loop delay search unit to search for an open-loop non-tonal codebook delay using the third spectrum and the contribution-removed sixth spectrum; and
a closed-loop delay and gain search unit to search for the closed-loop non-tonal codebook delay and a gain using the third spectrum and the contribution-removed first spectrum.

13. The frequency spectrum processing apparatus of claim 12, wherein the open-loop delay search unit comprises:
a spectrum division unit to divide the contribution-removed sixth spectrum according to a sub-band structure set for searching for the open-loop non-tonal codebook delay; and
a delay search unit to search for a delay having a largest normalized correlation between the third spectrum and the contribution-removed sixth spectrum in an open-loop search period corresponding to a current sub-band.

14. The frequency spectrum processing apparatus of claim 12, wherein the closed-loop delay and gain search unit comprises:
a spectrum division unit to divide the contribution-removed first spectrum, according to a sub-band structure set for searching for the closed-loop non-tonal codebook;
a search period determination unit to determine a closed-loop search period according to the open-loop non-tonal codebook delay;
an MDCT coefficient determination unit to set the third spectrum as an excitation signal in the closed-loop search period of the current sub-band, and determine an MDCT coefficient using the LP coefficient;
a delay search unit to search for a delay that minimizes an error between the MDCT coefficient and a quantized band coefficient in which the contribution of the tonal codebook is removed; and
a gain determination unit to determine a gain in the delay.

15. A frequency spectrum processing method comprising:
generating a first excitation spectrum using a tonal excitation spectrum according to an input signal and a gain of the tonal excitation spectrum;
generating a second excitation spectrum using a non-tonal excitation spectrum according to the input signal and a gain of the non-tonal excitation spectrum; and
generating an output spectrum using the first excitation spectrum and the second excitation spectrum.

16. A frequency spectrum processing method comprising:
transforming an input signal of a time domain into a first spectrum of a frequency domain;
determining a linear prediction (LP) coefficient by LP analyzing the first spectrum;
searching a tonal codebook that minimizes a difference between a second spectrum, the second spectrum which is LP synthesized by a tonal component including a periodic component of the input signal and the LP coefficient, and the first spectrum;
searching a non-tonal codebook that minimizes a difference between a third spectrum, the third spectrum which is LP synthesized by a non-tonal component including an aperiodic component of the input signal and the LP coefficient, and a fourth spectrum generated by removing a contribution of the tonal codebook from the first spectrum; and
a signal output unit to output an encoded signal using the LP coefficient, the tonal codebook, and the non-tonal codebook.

17. The frequency spectrum processing method of claim 16, wherein the searching of the tonal codebook comprises:
rearranging a sixth spectrum including residual information with respect to an LP coefficient according to a track structure for searching for the tonal codebook;
outputting an open-loop tonal codebook based on a size component with respect to the rearranged sixth spectrum; and
searching for a closed-loop tonal codebook using the open-loop tonal codebook, the LP coefficient, and the first spectrum.

18. The frequency spectrum processing method of claim 17, wherein the searching of the closed-loop tonal codebook comprises:
setting the open-loop tonal codebook as an optimal tonal codebook;
setting an error value of the first spectrum and the second spectrum as a minimum error value;
generating a candidate tonal codebook by substituting a pulse corresponding to a current track in the optimal tonal codebook with a pulse corresponding to a current position of a same track;
updating the minimum error value and the optimal tonal codebook by comparing a candidate error value of a seventh spectrum generated using the first spectrum and the candidate tonal codebook with the minimum error value; and
outputting the updated optimal tonal codebook to the closed-loop tonal codebook.

19. The frequency spectrum processing method of claim 16, further comprising:
outputting a low band signal bitstream by encoding a low band signal including a lower band of the input signal; and
outputting a third spectrum by transforming a layer signal obtained by decoding the low band signal transform.

20. The frequency spectrum processing method of claim 16, wherein the searching of the non-tonal codebook comprises:
removing a contribution of the first spectrum and the sixth spectrum;
searching for an open-loop non-tonal codebook delay using the third spectrum and the contribution-removed sixth spectrum; and
searching for the closed-loop non-tonal codebook delay and a gain using the third spectrum and the contribution-removed first spectrum.
